(19) United States
(12) Patent Application Publication
(10) Pub. No.: US 2025/0142321 A1
(43) Pub. Date: May 1, 2025

(54) METHODS, DEVICES, AND SYSTEMS FOR COORDINATING UE CAPABILITY FOR DUAL-ACTIVE STATE

(71) Applicant: ZTE Corporation, Shenzhen (CN)

(72) Inventors: Wenting LI, Shenzhen (CN); Jing LIU, Shenzhen (CN)

(21) Appl. No.: 19/006,490

(22) Filed: Dec. 31, 2024

Related U.S. Application Data
(63) Continuation of application No. PCT/CN2022/113068, filed on Aug. 17, 2022.

(51) Int. Cl. H04W 8/24

(52) U.S. Cl. CPC H04W 8/24

(57) ABSTRACT

The present disclosure describes methods, systems, and devices for coordinating user equipment (UE) capability for dual-active state. One method includes sending, by a UE, a first message comprising a first indicator to a network, the first indicator indicating a UE capability restriction to the network. Another method includes receiving, by a network, a first message comprising a first indicator from a UE, the first indicator indicating a UE capability restriction to the network.

### TECHNICAL FIELD

The present disclosure is directed generally to wireless communications. Particularly, the present disclosure relates to methods, devices, and systems for coordinating user equipment (UE) capability for dual-active state.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

For the 5th Generation (5G) mobile communication technology, a user equipment (UE), for example, a smart phone, may register with and connect to more than one network nodes at the same time.

The present disclosure may address at least some of issues/problems associated with the existing system and describes various embodiments for coordinating user equipment (UE) capability, improving the performance of the wireless communication.

### SUMMARY

This document relates to methods, systems, and devices for wireless communication, and more specifically, for coordinating user equipment (UE) capability for dual-active state.

In one embodiment, the present disclosure describes a method for wireless communication. The method includes sending, by a user equipment (UE), a first message comprising a first indicator to a network, the first indicator indicating a UE capability restriction to the network.

In another embodiment, the present disclosure describes a method for wireless communication. The method includes receiving, by a network, a first message comprising a first indicator from a user equipment (UE), the first indicator indicating a UE capability restriction to the network.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM).

The above and other aspects and their implementations are described in greater detail in the drawings, the descriptions, and the claims.

### BRIEF DESCRIPTION OF THE DRAWINGS

FIG. 1 shows an example of a wireless communication system include more than one network nodes and one or more user equipment.

FIG. 2 shows an example of a network node.

FIG. 3 shows an example of a user equipment.

FIG. 4 shows a flow diagram of a method for wireless communication.

FIG. 5 shows a flow diagram of a method for wireless communication.

FIG. 6 shows a schematic diagram of an exemplary embodiment for wireless communication.

FIG. 7 shows a schematic diagram of another exemplary embodiment for wireless communication.

FIG. 8 shows a schematic diagram of another exemplary embodiment for wireless communication.

FIG. 9 shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for coordinating user equipment (UE) capability for dual-active state.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

The present disclosure describes various embodiments for coordinating multiple networks in dual-active state. Under one or more scenarios, a user equipment (UE) may connect to more than one network nodes at the same time. The network nodes, for example, may include one or more radio access network (RAN) node and/or one or more core network (CN) node. In one implementation, the UE may connect with two network nodes at the same time, which may be referred as “dual-active state”, which need the UE and/or one or more network nodes to coordinate the multiple connections, so as to provide an efficient system for the one or more scenarios.

One scenario may include that, for a UE having multiple subscriber identity modules (Multi-SIMs) (or multiple universal subscriber identity modules (Multi-USIMs), the UE may connect with the multiple networks at the same time. In another scenario, a UE with a single SIM may connect with the multiple networks at the same time. Another scenario may include, a roaming UE may connect multiple networks for different slices.

When the UE configures to connect multiple network at the same time, the UE capability may need to be coordinated. In some implementations with radio access capability signalling (RACS), the UE radio access capability may be packaged as a predefined or network defined UE capability ID.

In various embodiments, for the Multi-SIM (or Multi-USIM), the UE may connect to multiple networks simultaneously for different cases.

In some implementations with paging receiving on a second subscriber identity module (SIM2) when a first subscriber identity module (SIM1) is at connected state, it may be solved by time division multiplexing (TDM), e.g. reserving the scheduling gap for the SIM2. There may be no cooperation for that there was not simultaneously connection with 2 networks. However, for the dual receiving/transmitting (RX) UE, this scheme may affect the performance of SIM1 by reserving scheduling gap with paging period. Another solution for the dual RX UE is to reserve part of radio frequency or physical (RF/PHY) resources for the paging receiving. In some implementations with short dual connected state, the SIM1 may be at connected state, and the SIM2 has to do some mobility update, e.g. periodic registration, moving into a new registration area, or response the paging. The UE may need capability cooperation during the short dual connected state. In some implementations with long dual connected state, the UE may have a voice call on the SIM1, meanwhile have some other data service on the SIM2. The UE may need capability cooperation.

There may be some issues/problems that need to be resolved. For example, Multi-SIM (or Multi-USIM) UE's hardware capabilities may be shared by more than one SIMs. To use the hardware efficiently and economically, the related capabilities need to be dynamically split between the more than one SIMs. This may lead to a temporary hardware conflict. For example, the UE is connected to one network (network A), it would have some capability restriction to another network (network B). Thus, the UE need to indicate the capability restriction to the network B when the UE enters into the connected state with network B.

The present disclosure describes various embodiments for coordinating user equipment (UE) capability for dual-active state, addressing at least one of issues/problems described above,, providing solutions and/or improving the performance of the wireless communication.

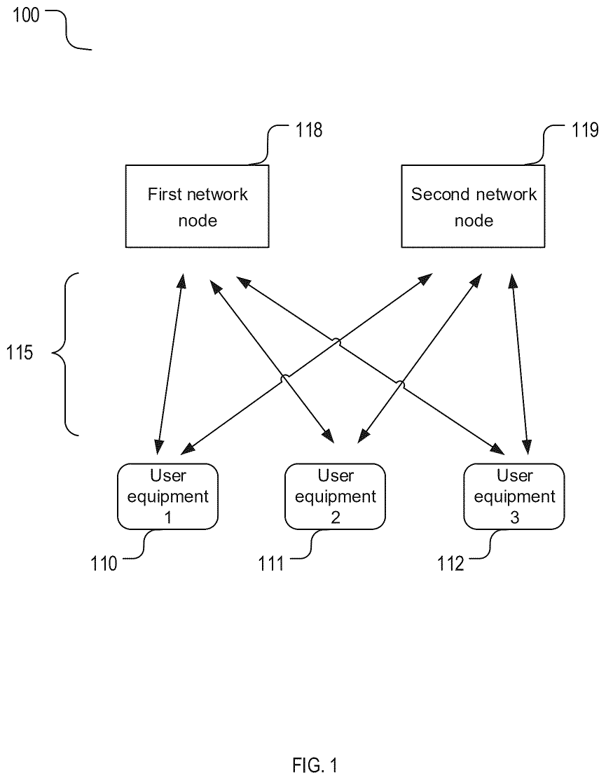

FIG. 1 shows a wireless communication system 100 including more than one wireless network nodes (118 and 119) and one or more user equipment (UE) (110, 111, and 112).

For the 5th Generation mobile communication technology, a UE 110, for example, a smart phone, may have a single subscriber identity module (SIM) or multiple subscriber identity modules (Multi-SIMs). When the UE has a single SIM, the UE may connect to one network node 118, for example, a radio access network (RAN) node and/or a core network (CN) node, or may connect to more than one network nodes (118 and 119), for example, two RAN nodes and/or two CN nodes. When the UE has Multi-SIMs, the UE may connect to more than one network nodes (118 and 119), for example, two RAN nodes, two CN nodes, and/or one RAN node and one CN node.

The wireless network node (118 and 119) may include a network base station, which may be a nodeB (NB, e.g., eNB, or gNB) in a mobile telecommunications context. Each of the UE (110, 111, and/or 112) may wirelessly communicate with the wireless network node (118 and/or 119) via one or more radio channels 115. For example, the first UE 110 may wirelessly communicate with the first network node 118 via a channel including a plurality of radio channels during a certain period of time; during another period of time or simultaneously at the same time, the first UE 110 may wirelessly communicate with the second network node 119 via a channel including a plurality of radio channels.

The present disclosure describes various embodiments for coordinating user equipment (UE) capability for dual-active state for at least one scenario, including but not limited to the scenarios as discussed above. The present disclosure describes methods, systems, and storage medium of how the UE and/or one or more network nodes coordinate the UE capability (e.g., UE capability restriction information) among the UE and the multiple network nodes.

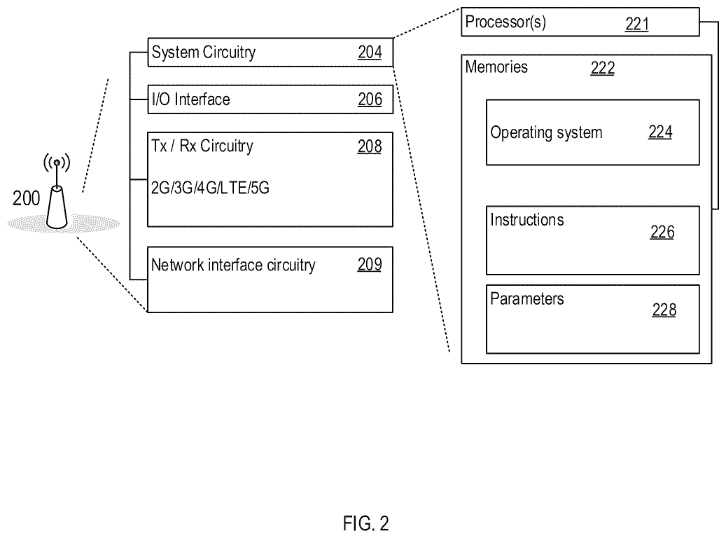

FIG. 2 shows an example of electronic device 200 to implement a network node or network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

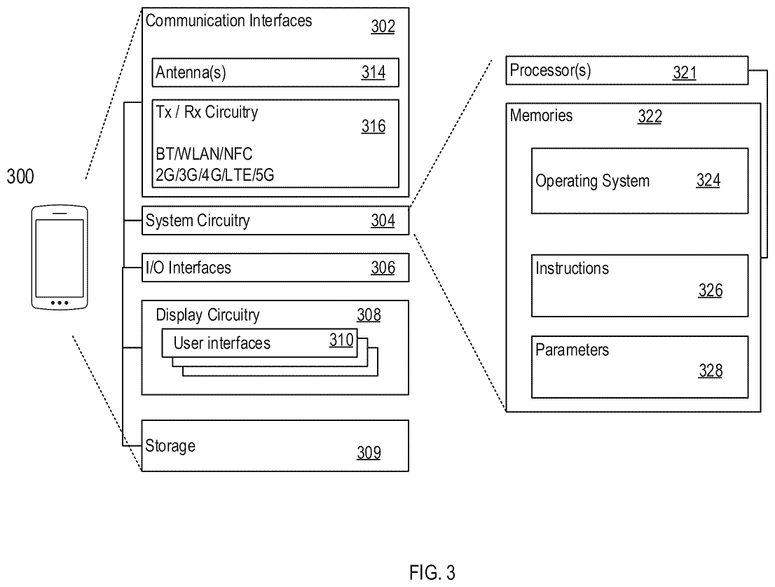

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310.

The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G, and/or further developed standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

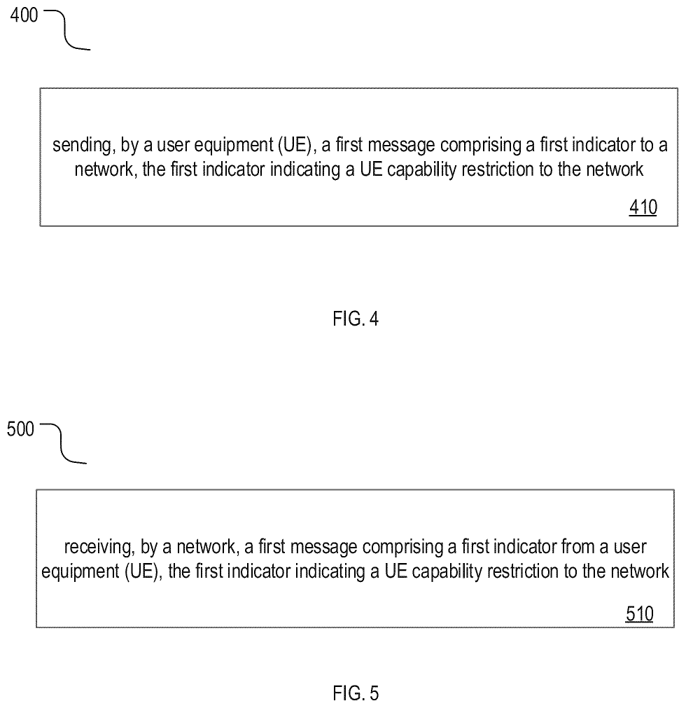

Referring to FIG. 4, the present disclosure describes embodiments of a method 400 for wireless communication. The method 400 may include step 410, sending, by a user equipment (UE), a first message comprising a first indicator to a network, the first indicator indicating a UE capability restriction to the network.

Referring to FIG. 5, the present disclosure describes embodiments of a method 500 for wireless communication. The method 500 may include step 510, receiving, by a network, a first message comprising a first indicator from a user equipment (UE), the first indicator indicating a UE capability restriction to the network.

Without limitation to the present disclosure, the various embodiments described below may use a UE with the Multi-SIMs. These embodiments are examples and do not limit the present disclosure, and the present disclosure may also be applied to the other scenarios that a UE connect to the two networks simultaneously.

In some implementations, in additional to a portion or a combination of implementations or embodiments described in the present disclosure, the UE comprises multiple universal subscriber identification modules (Multi-USIMs) corresponding to the first subscription and the second subscription.

In some implementations, in additional to a portion or a combination of implementations or embodiments described in the present disclosure, the first message comprises one of the following: a message one (Msg 1), a message A (Msg A), a message three (Msg 3), or a message five (Msg 5).

In some implementations, in additional to a portion or a combination of implementations or embodiments described in the present disclosure, the method 400 may include, before the UE sends the first message to the network: the UE is in an idle state with the network; and/or the UE configures to establish connection with the network.

In some implementations, in additional to a portion or a combination of implementations or embodiments described in the present disclosure, the first message comprises one of the following: a radio resource control (RRC) setup request message, or an RRC setup complete message.

In some implementations, in additional to a portion or a combination of implementations or embodiments described in the present disclosure, the method 400 may include, before the UE sends the first message to the network: the UE is in an inactive state with the network; and/or the UE configures to resume connection with the network.

In some implementations, in additional to a portion or a combination of implementations or embodiments described in the present disclosure, the first message comprises one of the following: a radio resource control (RRC) resume request message, or an RRC Resume complete message.

In some implementations, in additional to a portion or a combination of implementations or embodiments described in the present disclosure, the first indicator comprises a field indicating a capability restriction of the UE to the network.

In some implementations, in additional to a portion or a combination of implementations or embodiments described in the present disclosure, in response to sending the first message comprising the first indicator, the UE receives a second message comprising a second indicator from the network, the second indicator indicating a request for the UE to report the UE capability restriction.

In some implementations, in additional to a portion or a combination of implementations or embodiments described in the present disclosure, the second message comprises one of an RRC message or a medium access control control element (MAC CE); and/or the RRC message comprises a reconfiguration message.

In some implementations, in additional to a portion or a combination of implementations or embodiments described in the present disclosure, in response to receiving the second message, the UE sends a third message comprising the UE capability restriction information to the network.

In some implementations, in additional to a portion or a combination of implementations or embodiments described in the present disclosure, in response to sending the third message comprising the UE capability restriction information, the UE receives a fourth message to reconfigure the UE from the network.

In some implementations, in additional to a portion or a combination of implementations or embodiments described in the present disclosure, the second indicator comprises a field for requesting the UE to report a capability restriction to the network.

In some implementations, in additional to a portion or a combination of implementations or embodiments described in the present disclosure, the method 400 may include, before the UE sends the first message to the network: the UE receives system information broadcasted by the network, the system information comprising a third indicator indicating that the network supports a capability restriction indication.

In some implementations, in additional to a portion or a combination of implementations or embodiments described in the present disclosure, the system information comprises a system information block one (SIB 1).

In some implementations, in additional to a portion or a combination of implementations or embodiments described in the present disclosure, the third indicator comprises a field for indicating at least one of the following: whether the UE is allowed to send a capability restriction indication, and/or whether the network supports a capability restriction reporting.

In some implementations, in additional to a portion or a combination of implementations or embodiments described in the present disclosure, the first message comprises one of the following: a radio resource control (RRC) resume request message, an RRC Resume complete message, an RRC setup request message, or an RRC setup complete message.

In some implementations, in additional to a portion or a combination of implementations or embodiments described in the present disclosure, in response to receiving the first message comprising the indicator, the network sends a second message comprising a second indicator to the UE, the second indicator indicating a request for the UE to report the UE capability restriction.

In some implementations, in additional to a portion or a combination of implementations or embodiments described in the present disclosure, in response to sending the second message, the network receives a third message comprising the UE capability restriction information from the UE.

In some implementations, in additional to a portion or a combination of implementations or embodiments described in the present disclosure, in response to receiving the third message comprising the UE capability restriction information, the network sends a fourth message to reconfigure the UE.

In some implementations, in additional to a portion or a combination of implementations or embodiments described in the present disclosure, the method 500 may include: the network receives the first message from the UE: the network broadcasts system information to the UE, the system information comprising a third indicator indicating that the network supports a capability restriction indication.

The present disclosure describes various exemplary embodiments for coordinating user equipment (UE) capability for dual-active state, which serve as examples and do not impose any limitation on the present disclosure.

Various embodiments address at least the issue of how a UE indicates the temporary capability restriction during the connection establish procedure. A UE may send an early indication that indicates there is temporary capability restriction before reconfigure the UE. The UE may send the early indication in a message during the connection setup or connection resume procedure. For non-limiting example, the message may include Msg 1, Msg A, Msg 3, or Msg 5. The Msg 3 may include an RRCSetupRequest message or an RRC resume Request message; and/or the Msg 5 may include an RRCSetupComplete message or an RRC resume complete message.

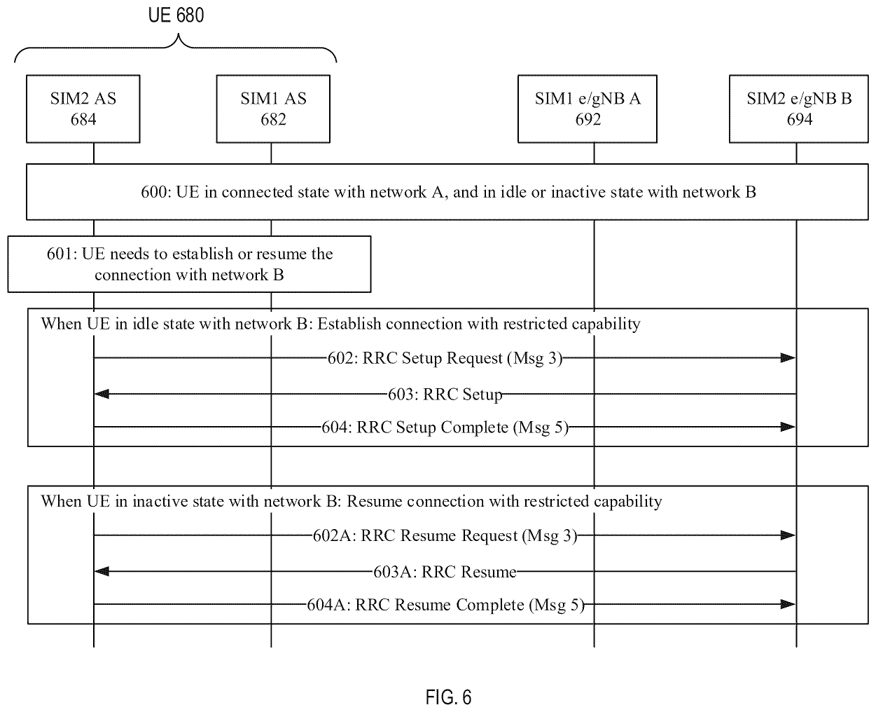

In some implementations, referring to FIG. 6, a UE (680) may include an early indication that indicates the temporary capability restriction in Msg 3 in step 602 (or step 602A) or Msg 5 in step 604 (or step 604A). The UE 680 may include a SIM1 access stratum (AS) 682 and a SIM2 AS 684, which are configured to connect to a SIM1 e/gNB A 692 and a SIM2 e/gNB B 694, respectively.

Referring to step 600: the UE may be in a connected state with the network A (692), and the UE may be in an idle or inactive state with network B.

Referring to step 601: the UE may need to establish the connection with the network B (when UE was in an idle state with the network B); or the UE may need to resume the connection with the network B (when UE was in an inactive state with the network B).

When the UE is in the idle state with the network B, and needs to establish connection with restricted capability, steps 602, 603, and 604 may be performed.

Referring to step 602, the UE may send an RRC setup request message (or Msg 3) to the network B. Referring to step 603, in response to receiving the RRC setup request message, the network B may send an RRC setup message. Referring to step 604, in response to receiving the RRC setup message, the UE sends an RRC setup complete message (or Msg 5) to the network B. In some implementations, the RRC setup request message in step 602 may include the UE capability restrict indication. In some other implementations, the RRC setup complete message in step 604 may include the UE capability restrict indication.

When the UE is in the inactive state with the network B, and needs to resume connection with restricted capability, steps 602A, 603A, and 604A may be performed.

Referring to step 602A, the UE may send an RRC resume request message (or Msg 3) to the network B. Referring to step 603A, in response to receiving the RRC resume request message, the network B may send an RRC resume message. Referring to step 604A, in response to receiving the RRC resume message, the UE sends an RRC resume complete message (or Msg 5) to the network B. In some implementations, the RRC resume request message in step 602A may include the UE capability restrict indication. In some other implementations, the RRC resume complete message in step 604A may include the UE capability restrict indication.

In some implementations, Asn.1 coding may be used for the UE capability restrict indication. For a non-limiting example, Asn.1 coding may be below for the UE capability restrict indication in an RRC setup complete message:

CapRestrict Indication ENUMERATED {true} Optional wherein CapRestrictIndication may be used to indicate there is temporary capability restriction at UE side.

Various embodiments address at least the issue of how a network node acts when receiving the temporary capability restriction. When receiving an early indication that indicates there is temporary capability restriction, the network may request the UE to report temporary capability.

In some implementations, the network may request the UE to report the temporary capability restriction in an RRC message or an MAC CE. For example, the RRC message may be a reconfiguration message.

In some implementations, once the UE receives the request, the UE may report the temporary capability restriction in a UE assistance information (UAI).

In some implementations, once the network gets the temporary capability restriction, the network may reconfigure the UE.

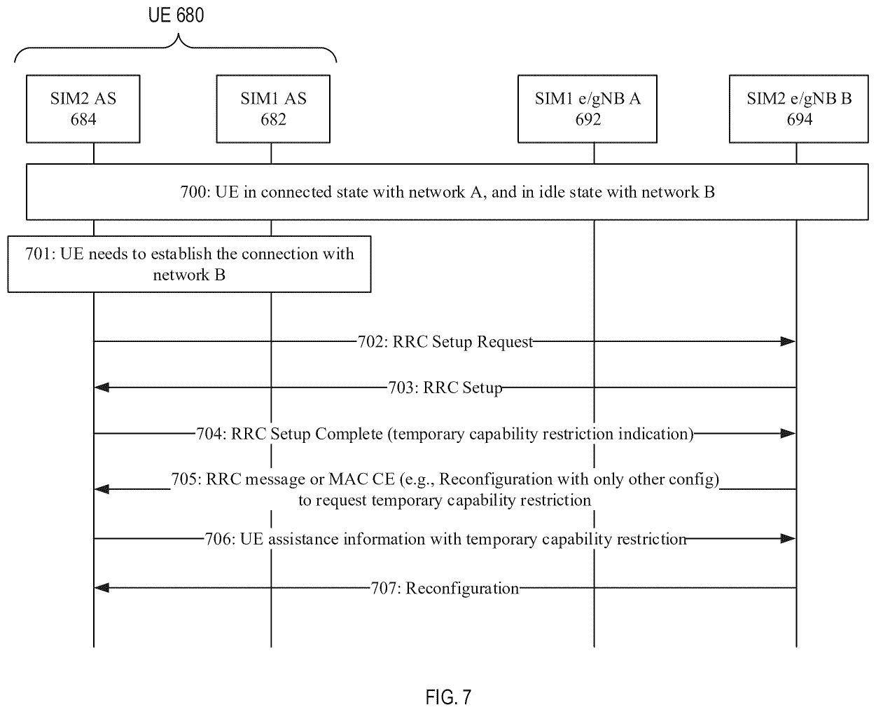

In some implementations, referring to step 700 in FIG. 7: the UE may be in a connected state with the network A, and the UE may be in an idle state with network B. Referring to step 701: the UE may need to establish the connection with the network B when UE was in an idle state with the network B. Referring to step 702, the UE may send an RRC setup request message to the network B. Referring to step 703, in response to receiving the RRC setup request message, the network B may send an RRC setup message. Referring to step 704, in response to receiving the RRC setup message, the UE sends an RRC setup complete message including a temporary capability restriction indication to the network B. Referring to step 705, in response to receiving the temporary capability restriction indication from the UE, the network B may send an RRC message (or MAC CE) including reconfiguration (e.g., other configuration) to request temporary capability restriction. Referring to step 706, in response to receiving the request for temporary capability restriction from the network B, the UE may send UE assistant information including the temporary capability restriction to the network B. Referring to step 707, in response to receiving the temporary capability restriction from the UE, the network B may reconfigure the UE by sending a reconfiguration message to the UE.

In some implementations, Asn.1 coding may be used for the request for capability restrict (or restriction). For a non-limiting example, Asn.1 coding may be below for the request for capability restrict contained in a reconfiguration (Reconfiguration->OtherConfig):

CapRestrictRequest Indication ENUMERATED {true} Optional wherein CapRestrictRequestIndication may be used to request the UE to report the temporary capability restriction.

Various embodiments address at least the issue of when a UE sends the early indication (i.e., a trigger condition for the UE). The UE needs to know whether the network B support early indication that indicates there is the temporary capability restriction. The network may indicate that it supports temporary capability restriction reporting in the system Information.

In some implementations, an indication may be contained in a SIB1, which is used to indicate whether the UE is allowed to send early indication that indicates there is the temporary capability restriction and/or is used to indicate whether it supports temporary capability restriction reporting.

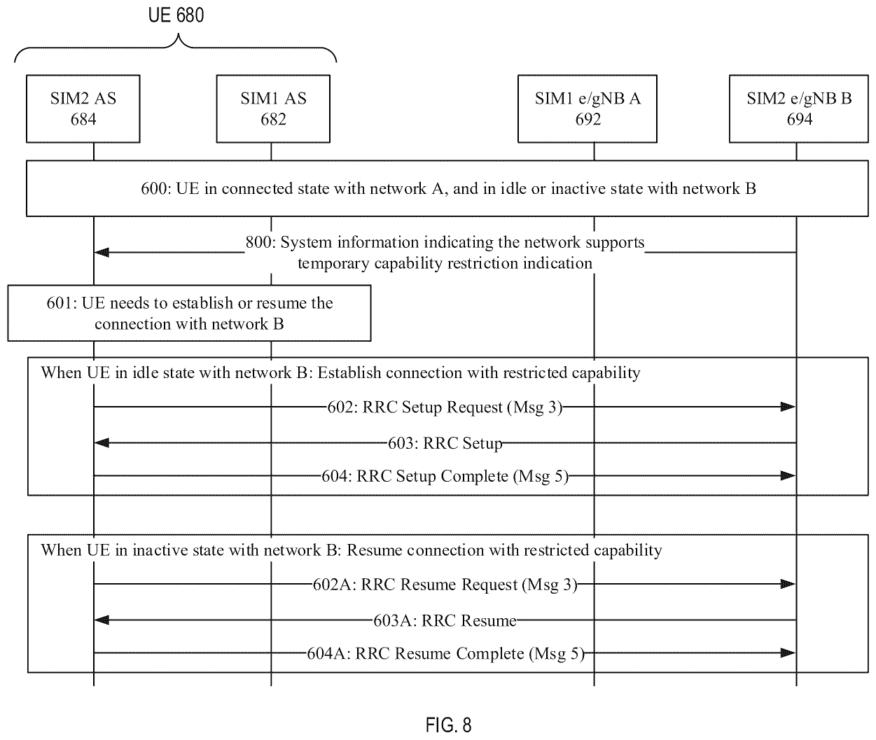

In some implementations, referring to FIG. 8: in step 800, the network B may broadcast a system information indicating that the network B supports temporary capability restriction indication. Steps 600, 601, 602, 603, and 604 (or 602A, 603A, and 604A) may be the same as previously described in other embodiments. step 800 may be performed in other sequence related to other steps: for one example, step 800 may occur before step 600; for another example, step 800 may occur after step 600; for another example, step 800 may occur before step 601; and/or for another example, step 800 may occur after step 601.

In some implementations, Asn.1 coding may be used for indicating whether the network supports temporary capability restriction reporting. For a non-limiting example, Asn.1 coding may be below for indicating whether the network supports temporary capability restriction reporting in the SIB1:

CapRestrictSupport Indication ENUMERATED {true} Optional wherein, CapRestrictSupportIndication may indicate whether the UE is allowed to send “early indication that indicates there is the temporary capability restriction” or to indicate whether the network support supports temporary capability restriction reporting.

Various embodiments describe some enhancement for a UE in an inactive state with restricted capability. When the UE in the inactive state, the UE may send RRC resume request to the network B. However, because of the temporary capability restriction, the connection may not be resumed successfully, for example, when the network doesn't know that there is a temporary capability restriction. For this case, when the early indication is needed, the UE has to send the early indication in the resume request message. However, because of the size limitation of the resume request message, it may not be desirable to use the remaining 1 spare bit for MUSIM feature. Thus, as an enhanced mechanism/solution, the UE may enter an idle state directly.

In some implementations, for the case that the UE may be unable to resume the connection, the UE can enter into idle sate immediately; and/or when it is needed, the UE may send an RRC setup procedure after entering the idle state.

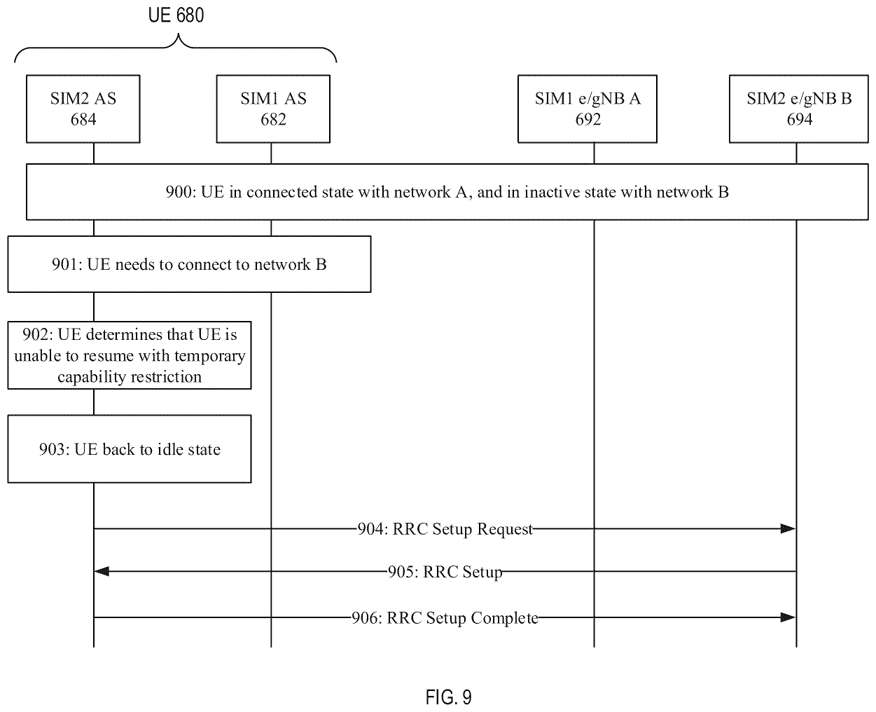

In some implementations, referring to step 900 in FIG. 9: the UE may be in a connected state with the network A, and the UE may be in an inactive state with network B. Referring to step 901: the UE may need to connect to the network B. Referring to step 902, the UE may determines that the UE needs to go back to the idle state because the UE determines that the UE may be unable to resume the connection with the network B due to the temporary capability (restrictions). Referring to step 903, the UE is back to the idle state. Referring to step 904, the UE may send a RRC setup request message to the network B. Referring to step 905, in response to receiving the RRC setup request message, the network B may send an RRC setup message. Referring to step 906, in response to receiving the RRC setup message, the UE sends an RRC setup complete message to the network B. In some implementations, the RRC setup request message may include the temporary capability restriction (or indication). In some implementations, the RRC setup complete message may include the temporary capability restriction (or indication).

Referring to FIG. 9, step 902 may be optional and may not be necessary to some implementations, wherein the UE enters back to the idle state without determining whether/that the UE needs to go back to the idle state and/or without determining whether/that the UE may be unable to resume the connection with the network B due to the temporary capability (restrictions).

The present disclosure describes methods, apparatus, and computer-readable medium for wireless communication. The present disclosure addressed the issues with coordinating user equipment (UE) capability for dual-active state. The methods, devices, and computer-readable medium described in the present disclosure may facilitate the performance of wireless transmission between a user equipment and multiple network nodes, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
sending, by a user equipment (UE), a first message comprising a first indicator to a network, the first indicator indicating a UE capability restriction to the network.

2. The method according to claim 1, wherein:
the UE comprises multiple universal subscriber identification modules (Multi-USIMs) corresponding to a first subscription and a second subscription.

3. The method according to claim 1, wherein:
the first message comprises a message five (Msg 5).

4. The method according to claim 1, wherein, before the UE sends the first message to the network:
the UE is in an idle state with the network; and
the UE configures to establish connection with the network.

5. The method according to claim 4, wherein:
the first message comprises an RRC setup complete message.

6. The method according to claim 1, wherein, before the UE sends the first message to the network:
the UE is in an inactive state with the network; and
the UE configures to resume connection with the network.

7. The method according to claim 6, wherein:
the first message comprises an RRC Resume complete message.

8. The method according to claim 1, wherein:
the first indicator comprises a field indicating a capability restriction of the UE to the network.

9-13. (canceled)

14. The method according to claim 1, wherein, before the UE sends the first message to the network:
the UE receives system information broadcasted by the network, the system information comprising a third indicator for indicating that the UE is allowed to send the first indicator in the first message.

15. The method according to claim 14, wherein:
the system information comprises a system information block one (SIB 1).

16. (canceled)

17. A method for wireless communication, comprising:
receiving, by a network, a first message comprising a first indicator from a user equipment (UE), the first indicator indicating a UE capability restriction to the network.

18. The method according to claim 17, wherein:
the first message comprises one of the following: an RRC Resume complete message, or an RRC setup complete message.

19. (canceled)

20. (canceled)

21. (canceled)

22. The method according to claim 17, wherein, before the network receives the first message from the UE:
the network broadcasts system information to the UE, the system information comprising a third indicator for indicating that the UE is allowed to send the first indicator in the first message.

23. (canceled)

24. (canceled)

25. A user equipment (UE) comprising:
a memory storing instructions; and
at least one processor in communication with the memory, wherein, when the at least one processor executes the instructions, the at least one processor is configured to cause the UE to perform:
sending a first message comprising a first indicator to a network, the first indicator indicating a UE capability restriction to the network.

26. The UE according to claim 25, wherein, before the at least one processor is configured to cause the UE to perform sending the first message to the network,
the UE is in an idle state with the network; and
the UE configures to establish connection with the network.

27. The UE according to claim 26, wherein:
the first message comprises an RRC setup complete message.

28. The UE according to claim 25, wherein, before the at least one processor is configured to cause the UE to perform sending the first message to the network,
the UE receives system information broadcasted by the network, the system information comprising a third indicator for indicating that the UE is allowed to send the first indicator in the first message.

29. A network comprising:
a memory storing instructions; and
at least one processor in communication with the memory, wherein, when the at least one processor executes the instructions, the at least one processor is configured to cause the network to perform:
receiving a first message comprising a first indicator from a user equipment (UE), the first indicator indicating a UE capability restriction to the network.

30. The network according to claim 29, wherein:
the first message comprises one of the following: a radio resource control (RRC) Resume complete message, or an RRC setup complete message.

31. The network according to claim 29, wherein, before the at least one processor is configured to cause the network to perform receiving the first message from the UE,
the network broadcasts system information to the UE, the system information comprising a third indicator for indicating that the UE is allowed to send the first indicator in the first message.
